(19) United States
(12) Patent Application Publication
(10) Pub. No.: US 2017/0210442 A1
(43) Pub. Date: Jul. 27, 2017

(54) Linked Dual Action Motorcycle Hydraulic Clutch Actuator

(71) Applicant: Fernando Aguilar, Albuquerque, NM (US)

(72) Inventor: Fernando Aguilar, Albuquerque, NM (US)

(21) Appl. No.: 15/005,649

(22) Filed: Jan. 25, 2016

(51) Int. Cl. B62K 23/06; F16D 25/12; B62K 23/08

(52) U.S. Cl. CPC B62K 23/06; B62K 23/08; F16D 25/12

(57) ABSTRACT

Disclosed is a motorcycle clutch actuator, with hydraulically linked foot clutch lever and hand clutch lever, to be installed on motorcycles made with a hand activated gear selection lever or on motorcycles to be converted from a conventional configuration of hand activated clutch and foot activated gear selection lever, to a configuration of foot activated clutch and hand activated gear selection lever, providing optimal clutch control with either a foot clutch lever or a hand clutch lever, by means of innovative hydraulic and mechanical control linkage, releasing the rider's foot from the foot clutch lever, while holding the clutch in the disengaged position with a hand clutch lever, as the motorcycle is running while in gear, thereby enabling the rider to balance the motorcycle with both feet while modulating the clutch with the hand clutch lever.

### REFERENCE TO RELATED APPLICATIONS

This application is a continuation in part of: United States Patent Application Publication Number 2015/0284046 of Aguilar; Fernando published on Oct. 8, 2015, Application Ser. No. 14/248,281, Filed on Apr. 8, 2014, for LINKED DUAL ACTION MOTORCYCLE CLUTCH ACTUATOR all of which is hereby incorporated by reference thereto.

### BACKGROUND OF THE INVENTION

1. Field of the Invention

The present invention relates to a motorcycle clutch with linked foot and hand hydraulic clutch actuators that enables foot or hand activation of a motorcycle clutch for installation on motorcycles made with a hand activated gear selection lever or that have been retrofitted from a configuration of a hand activated clutch and foot activated gear selection lever, to a configuration of a foot activated clutch and hand activated gear selection lever. It employs linked foot and hand hydraulic actuators that eliminate impediments to precise and predictable clutch operation and imparts a high degree of safety in the operation of a motorcycle by allowing the clutch to be held in the disengaged position with either the foot or hand with the motorcycle running while in gear.

2. Description of the Prior Art

Contemporary motorcycles are generally equipped with mechanical clutches as part of the drive train, which provide the interface between the motor output shaft and the transmission. These clutches are activated by pulling a hand lever on the left handlebar, which in turn drives a Bowden cable that is attached to the clutch. Later motorcycles may also be equipped with a hydraulic link between the hand lever and the clutch. Gear selection on contemporary motorcycles is accomplished by the up and down movement of a foot lever on the left side of the motorcycle. However, as late as the mid-1950s, vintage motorcycles were equipped with foot operated clutches and gear selection levers that were operated by hand. Such motorcycles include early Harley-Davidson™, Moto Guzzi™, Excelsior-Henderson™, BMW™ and Indian™ motorcycles, in addition to many others.

Today the motorcycle world is trending to an appreciation of the form and function of vintage motorcycles. Motorcycle enthusiasts are increasingly attracted to “cruiser” class motorcycles that emulate the look of older motorcycles. To more closely mimic the vintage look, contemporary motorcyclists find themselves retrofitting their motorcycles with “aftermarket” foot clutch levers as well as gear selection levers that are actuated by hand.

Current aftermarket foot clutch actuators, for retrofitting of contemporary motorcycles, provide a link from a foot clutch lever, generally on the left side of the motorcycle, via a Bowden cable that is sharply arched to the side of the motorcycle where the cable connects with the clutch mechanism. The location to which the cable connects with the original equipment manufacturer clutch mechanism is generally behind the motor, on the right side of the motorcycle. When the foot lever is activated, the cable transmits the force to the final element of the original equipment manufacturer motorcycle clutch, thereby disengaging the clutch and allowing the motorcycle operator to change gears with the hand operated gear change lever.

However this configuration causes imprecise and rough clutch engagement because of flawed geometric relationships between the foot lever and the insufficient arc of travel of the foot clutch lever over the small displacement imparted to the clutch cable. This results in frequent stalls and erratic starts which may pose a safety issue.

In addition, since the position of the motorcycle clutch mechanism and transmission is behind the motor, this places the foot actuated clutch lever in front of and far removed from the clutch mechanism. Current aftermarket foot clutch actuators produce tremendous friction between the cable and cable housing over a sharp bend of up to 180 degrees. This results sluggish clutch engagement and lack of engagement feedback, further exacerbating accurate clutch actuation which results in frequent stalls and erratic starts.

Current aftermarket foot clutch actuators do not provide a means of holding the clutch in a disengaged position to allow both of the operator's feet on the ground to balance the motorcycle when stopped with the motor idling while still in gear.

Current aftermarket foot clutch actuators also do not provide a linked hand clutch actuation option for re-engaging the clutch from a stationary position.

Current aftermarket foot clutch actuators also do not provide a linked hand clutch option for modulating the clutch during precision slow speed operations when both feet must be available for balancing the motorcycle.

Current aftermarket foot clutch actuators also do not provide a linked hand clutch option for accomplishing an emergency stop, with motor running and the transmission in gear, thus allowing both feet to be free for balancing the motorcycle.

Current aftermarket foot clutch actuators do not provide a means of eliminating friction in a contorted Bowden cable, resulting in erratic clutch operation and vague clutch engagement feedback, which induce frequent stalls and erratic starts.

During an emergency scenario in which the motorcycle operator must abruptly stop and balance the motorcycle with both feet on the ground, he or she will not have time to find the neutral position on the transmission and will need to hold the clutch in the disengaged position while bringing the motorcycle to a complete stop. This action allows the engine to idle while still in gear. Conventional motorcycles with the modern foot gear shift, hand clutch configurations allow for safe emergency stops while the motorcycle is in gear and both feet are required on the ground after stopping, by the operator applying simultaneous positive pressure on the left hand clutch lever, right hand front brake lever and right foot rear brake lever. Before the motorcycle comes to a complete stop the motorcycle operator will have free use of both feet to balance the motorcycle while the clutch is held in the in the disengaged position with the left hand and the motorcycle is maintained motionless by means of the front hand brake while the motorcycle is idling and in gear.

During a routine planned stop, the motorcycle operator riding a modern motorcycle retrofitted with an aftermarket foot clutch actuator may have the presence of mind to find the neutral position on the transmission before stopping, allowing him or her to release the foot clutch and place both feet on the ground to balance the stopped motorcycle and maintain it in the motionless state by means of the front hand brake.

However in an emergency situation involving a modern motorcycle retrofitted with an existing aftermarket foot clutch actuator, wherein the operator must accomplish an abrupt stop with the motorcycle in gear, the operator would not be able to hold the clutch in the disengaged position with the left foot when both feet must be available for balancing the motorcycle. This scenario can result in either a total inability of the rider to stop the motorcycle altogether, or a much longer stopping distance since the motorcycle brakes would be working against the still engaged motor, or a stalled motorcycle. Either result endangers the motorcycle operator and rider as well as pedestrians and the motoring public.

U.S. Pat. No. 5,662,195 A (Shifter assembly conversion kit) describes a gear shift conversion kit and method for converting a foot-operated shift mechanism and a hand-operated clutch mechanism on a motorcycle to a hand-operated shift mechanism and a foot-operated clutch mechanism. The clutch actuation mechanism described in U.S. Pat. No. 5,662,195 A is limited to clutch actuation via foot control only and does not provide for dual clutch actuation capability via linked foot lever and hand lever. Generally, this type of aftermarket clutch actuator imparts tremendous friction between the cable and cable housing resulting in lack of engagement feedback, further exacerbating inaccurate clutch actuation resulting in frequent stalls and erratic starts. In addition, this type of foot clutch configuration is limited by the small displacement of the arc of travel of the foot clutch lever, preventing precise and smooth clutch re-engagement.

U.S. Pat. No. 4,316,531 A (Clutch lockout latch) is a manually operated latch mounted on the handlebar of a motorcycle to engage the hand clutch control lever for holding the clutch in a locked-out position or in a partially disengaged position. This invention allows for the motorcycle operator to put the hand operated clutch in the disengaged position without having to maintain positive pressure on hand clutch lever. The invention described in U.S. Pat. No. 4,316,531 is limited to clutch actuation via hand control only and does not provide for linked dual clutch actuation capability via foot lever and hand lever. In addition this invention would not allow the rider to use a hand operated gear selection lever.

U.S. Pat. No. 2,540,926 A (Conversion unit for motorcycles) relates to an attachment for vintage (1950s & earlier) motorcycles to convert them from the foot clutch, hand gear shift configuration to hand clutch, foot gear shift configuration. This invention is the direct antithesis of what the present invention seeks to accomplish. In addition the invention described in U.S. Pat. No. 2,540,926 A is limited to clutch actuation via hand control only and does not provide for dual clutch actuation capability via linked foot lever and hand lever. Furthermore, this invention eliminates the use of a hand operated gear selection lever.

U.S. Pat. No. 2,094,163 A (Gear controlling means for motorcycles) provides for hand and foot controls for the gear selection on a motorcycle. Clutch actuation is accomplished with a hand lever on the handlebar. The invention described in U.S. Pat. No. 2,094,163 A is limited to clutch actuation via hand control only and does not provide for dual clutch actuation capability via linked foot lever and hand lever.

U.S. Pat. No. 5,299,652 A (Motorcycle controls for physically challenged rider) relates to a handlebar control system for a motorcycle which enables complete control of the motorcycle without moving the hands from the handlebars. The invention described in U.S. Pat. No. 5,299,652 A does not provide for a foot operated clutch.

Patent number WO 2005100143 A1 (Motorcycle gear shift control) provides for a foot operated gear-shift assembly, gear shift conversion kit, and method for changing gear shifting actions of a conventional motorcycle wherein the heel and toe shift elements of the conventional rocker-arm gear shift assembly are separated and rotate about separate pivot axes. The invention described in patent number WO 2005100143 A1 simply alters the foot shift mechanism, and gear selection is still accomplished via foot control. This precludes the use of a foot operated clutch. In addition, this invention does not provide for a hand operated gear selection lever.

U.S. Pat. No. 6,945,376 B1 (Foot Operated Motorcycle Clutch) is a foot-operated clutch mechanism to be installed on modern motorcycles to convert them from hand operated clutch to foot operated clutch. This mechanism is limited to clutch actuation via a foot lever only and does not provide for dual clutch actuation capability via linked foot lever and hand lever.

The custom motorcycle aftermarket also includes a hand operated gear selector lever with the hand operated clutch lever mounted to the gear selection lever. This configuration of hand clutch mounted on hand gear selection lever can be seen advertised in magazines, which cater to the custom motorcycle builder, such as “American Iron” and “Chopper”. This configuration requires the rider to initiate forward motion of a stationary motorcycle by engaging the clutch with the left hand away from the handlebar and only the right hand controlling the direction of the motorcycle. This embodiment makes it impossible to safely maneuver the motorcycle in very slow speed situations that require both feet on the ground and both hands on the handlebars while modulating the clutch. In addition, this embodiment is limited to clutch actuation via hand control only and does not provide for dual clutch actuation capability via foot lever and hand lever.

### SUMMARY OF THE INVENTION

The present invention is a motorcycle hydraulic clutch actuator that links hydraulic foot and hand clutch actuators that enable foot or hand activation of a motorcycle clutch for installation on motorcycles made with a hand activated gear selection lever or on motorcycles that have been retrofitted from a conventional modern day configuration of a hand activated clutch and foot activated gear selection lever, to an altered configuration of hand operated gear selection lever and a foot activated clutch.

The present invention may also be installed as original equipment on a modern motorcycle or used to retrofit an existing modern motorcycle. The device allows the rider to hold the clutch in the disengaged position with either a foot clutch lever or a hand clutch lever by employing a link between the foot clutch lever and the hand clutch lever. The device also allows the rider to engage the clutch through the release of positive pressure from a foot clutch lever or a hand clutch lever. The present invention employs linked foot and hand hydraulic clutch control so as to eliminate impediments to precise and predictable clutch operation and impart a high degree of safety in the operation of such a retrofitted motorcycle by allowing the clutch to be held in the disengaged position with either the foot or the hand, allowing the motor to idle while in gear.

It is therefore a primary object of the present invention, to provide the means for a rider of a motorcycle retrofitted with a hand gear selection lever and a foot actuated clutch lever to have the option to hold the clutch in the disengaged condition with the hand clutch lever, that is linked to the foot clutch lever, thus allowing the rider to remove his or her foot from the foot clutch lever to balance the motorcycle with both feet on the ground while the stationary motorcycle is still in gear and idling.

It is another object of the present invention to enable the rider of a motorcycle retrofitted with a hand gear selection lever and a foot actuated clutch to disengage and engage the clutch with the foot actuated clutch lever for the purpose of changing gears with the hand gear selection lever.

It is another object of the present invention to enable the rider of a motorcycle retrofitted with a hand gear selection lever and a foot actuated clutch to exercise precise and predictable clutch engagement through hydraulic control linkage.

It is a further object of the present invention to enable the rider of a motorcycle retrofitted with a hand gear selection lever and a foot actuated clutch, to sense accurate feedback during clutch operation by eliminating detrimental friction between a clutch control cable and the cable housing as well as any other element of the control linkage.

It is still another object of the present invention to enable the rider of a motorcycle retrofitted with a hand gear selection lever and a foot actuated clutch, to safely maneuver the motorcycle during very slow speed operations that requires both feet on the ground for “walking” the motorcycle, and both hands on the handlebars, while precisely modulating the clutch with the hand clutch lever.

It is still a further object of the present invention to enable the rider of a motorcycle retrofitted with a hand gear selection lever and a foot actuated clutch, to enable the rider to engage the clutch with a hand lever for the purpose of initiating forward motion of the motorcycle from a stationary position while releasing both feet to be on the ground for balancing the motorcycle.

It is still an even further object of the present invention to enable the rider of a motorcycle retrofitted with a hand gear selection lever and a foot actuated clutch, to accomplish a sudden emergency stop which would require both feet on the ground with the clutch disengaged via the hand clutch lever.

These and other objects of the present invention will become apparent to those skilled in this art upon reading the accompanying description, drawings, and claims set forth herein. The headings provided herein are for the convenience of the reader only. No headings should be construed to limiting upon the content in any way. The invention summarized above comprises the constructions hereinafter described, the scope of the invention being indicated by the subjoined claims.

### BRIEF DESCRIPTION OF THE DRAWINGS

FIG. 1 is a left hand view of a motorcycle with indications showing the location of the hand clutch lever 1, the hand clutch master cylinder 2, hydraulic line 15, and the assembly comprising of the hydraulic foot clutch lever and the mechanical arrangement linking the hydraulic hand clutch and foot clutch actuators according to the present invention.

FIG. 2 is a right side view of a motorcycle indicating the location of the hand clutch lever 1, the hand clutch master cylinder 2, hydraulic line 15, hydraulic line 16, and hydraulic actuator 9 that acts directly on the final element in the clutch actuation system according to the present invention.

FIG. 3 is a left side view of the assembly comprising a foot clutch lever 11 that is connected to a center pivot 13 of the bell crank 3 which links slave cylinder 5 and master cylinder 7 there by linking the hand clutch and foot clutch actuators according to the present invention.

FIG. 4 is a top view of the invention according to the present invention.

### DETAILED DESCRIPTION OF THE INVENTION

### 1. Definitions According to the Present Invention

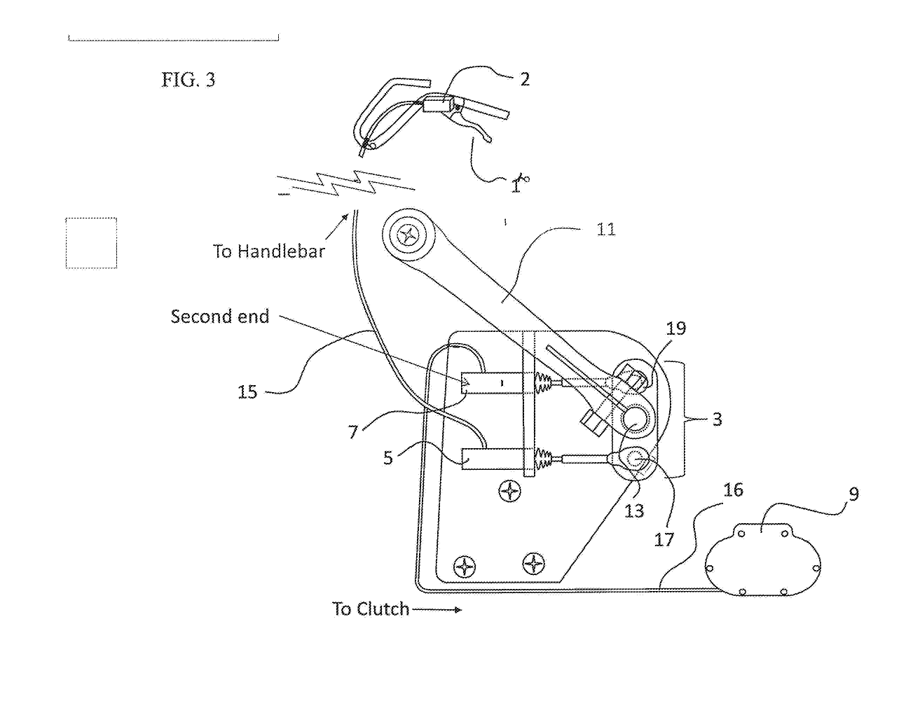

Center pivot of the bell crank [FIG. 3, 4]: Specific to the present invention, the center pivot of the bell crank 13 is a shaft for transmitting torque and rotational motion from foot clutch lever 11 to the bell crank 3.

Bell crank [FIG. 3, 4]: Specific to the present invention, the bell crank 3 links hydraulic actuator 5 to hydraulic actuator 7. The bell crank 3 converts the rotary force of the rotating shaft that is the center pivot of the bell crank 13 and is activated by the foot clutch lever 11 or hand clutch lever 1 to linear motion of the hydraulic actuators 5, 7. The bell crank contains a first 17 end and a second 19 end.

Hydraulic actuator [FIG. 3, 4]: Specific to the present invention, a hydraulic actuator 2, 5, 7, 9 consists of cylinder closed on one end, in which pressurized hydraulic fluid moves a piston connected to a piston rod, or non-hydraulic force moves a piston in a cylinder to pressurize and flow hydraulic fluid.

Master Cylinder [FIG. 3, 4]: Specific to the present invention a master cylinder 2, 7 is a hydraulic actuator that converts non-hydraulic force from the foot clutch lever or the hand clutch lever into hydraulic pressure that transfers the force via hydraulic fluid through tubular hydraulic lines to a slave cylinder. This results in displacement of a piston in the slave cylinder to actuate other elements of the clutch linkage.

Slave Cylinder [FIG. 3, 4]: Specific to the present invention, a slave cylinder 5, 9 is a hydraulic actuator that converts hydraulic force from a master cylinder 2, 7 where in the piston is displaced by pressurized hydraulic fluid and in turn actuates other elements of the clutch linkage.

Hydraulic control system [FIG. 3, 4]: Specific to the present invention, a master cylinder 2, 7 transmits the force of the foot clutch lever 11 or the hand clutch lever 1 by pressurizing and flowing hydraulic fluid through tubular hydraulic lines 15, 16. The flow and pressure of the hydraulic fluid redirects the force of the foot clutch lever 11 or the hand clutch lever 1 to actuate a piston within a slave cylinder 5, 9 which moves other elements of the clutch linkage.

Clutch actuation by foot clutch lever [FIG. 3, 4]: Specific to the present invention, by positive pressure from the foot, the foot clutch lever 11 is depressed thereby rotating the bell crank 3 about the center pivot of the bell crank 13. In turn the bell crank 3 pivots and actuates the master cylinder 7 which is connected to the second end 19 of the bell crank 3. This in turn actuates slave cylinder 9 for effective displacement of the final element in the clutch actuation system.

Clutch actuation by hand clutch lever [FIG. 3, 4]: Specific to the present invention, by positive pressure from the hand, the hand clutch lever 1 is depressed thereby actuating the hand clutch master cylinder 2 which in turn actuates the slave cylinder 5 which is connected to the first end 17 of the bell crank 3. This action in turn rotates the bell crank 3 about the center pivot of the bell crank 13 which actuates the master cylinder 7 which is connected to the second end 19 of the bell crank 3 which in turn actuates slave cylinder 9 for effective displacement of the final element in the clutch actuation system.

### 2. Best Mode of the Invention

FIG. 3, 4 show the side and top views of the best mode contemplated by the inventor of the linked dual action motorcycle hydraulic clutch actuator.

### 3. How to Make the Invention

The following will explain the means of making the invention.

The foot clutch lever 11 is connected to the center pivot of the bell crank 13 which is connected to the bell crank 3. Slave cylinder 5 is attached to the first end 17 of the bell crank 3. Master cylinder 7 is attached to the second end 19 of the bell crank 3.

Slave cylinder 5 is connected to master cylinder 2 via hydraulic tubing 15. Master cylinder 2 is actuated by hand clutch lever 1. Master cylinder 2 actuates slave cylinder 5 by flowing hydraulic fluid through hydraulic tubing 15.

Slave cylinder 5 which is connected to the first end 17 of the bell crank 3 actuates master cylinder 7 which is connected to the second end 19 of the bell crank 3 by rotating the bell crank 3 which is connected to the center pivot of the bell crank 13.

Slave cylinder 9 is connected to master cylinder 7 via hydraulic tubing 16. Master cylinder 7 is connected to the second end 19 of the bell crank 3 which is actuated by rotation of the bell crank 3, said rotation which is induced by actuating foot clutch lever 11 which in turn is connected to the bell crank 3 via the center pivot of the bell crank 13. Master cylinder 7 actuates slave cylinder 9 by flowing hydraulic fluid through hydraulic tubing 16. Slave cylinder 9 actuates the final element in the clutch actuation system.

Hydraulic tubing 16 connects master cylinder 7 to slave cylinder 9. Hydraulic tubing 16 can be routed from master cylinder 7 front of, under, over, behind or through the engine or motorcycle frame to slave cylinder 9.

### 4. How to Use the Invention

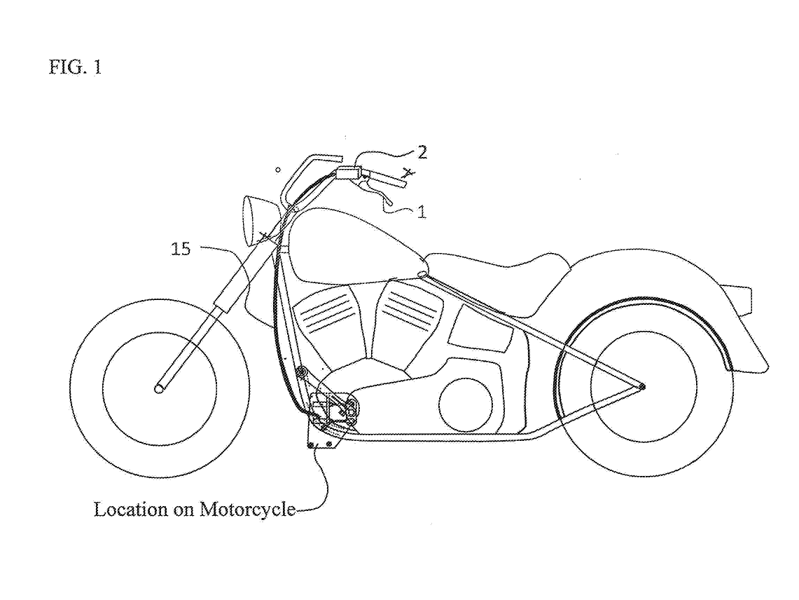

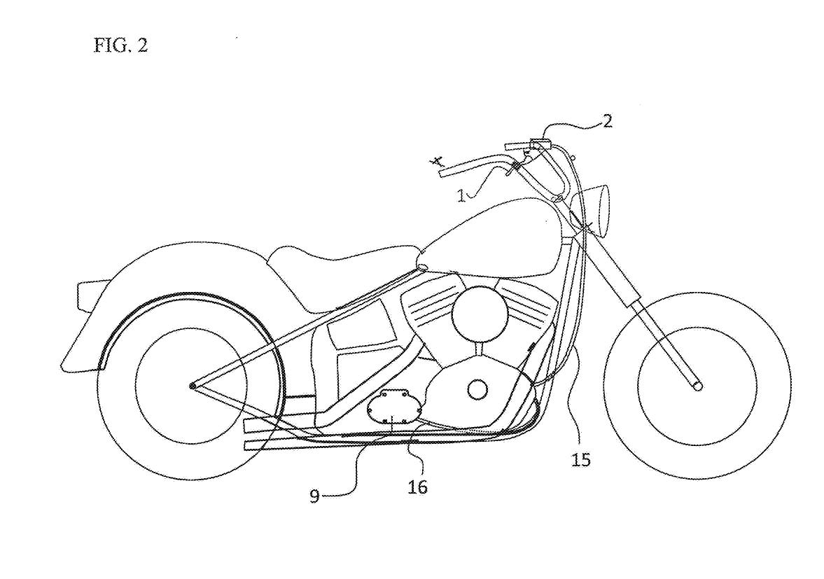

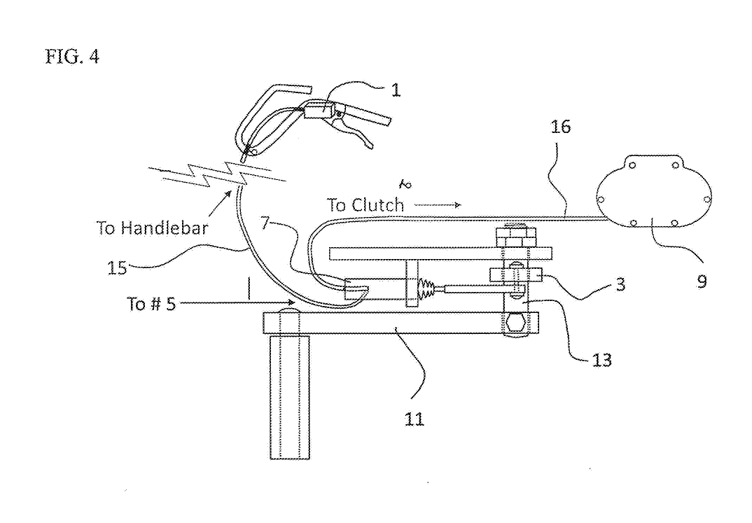

The problems remediated by the linked dual action motorcycle hydraulic clutch actuator FIG. 1-4 become easily apparent by those skilled in the art. For motorcycles made with a hand activated gear selection lever or have been retrofitted from a configuration of a hand lever activated clutch and foot activated gear selection lever, to a configuration of a foot lever activated clutch and hand activated gear selection lever, the linked dual action motorcycle hydraulic clutch actuator FIG. 1-4 prevents motorcycle accidents for motorcycles with hand gear selection levers that have been retrofitted with this invention. The linked dual action motorcycle hydraulic clutch actuator FIG. 1-4 prevents injury to the motorcycle operator and passenger. The linked dual action motorcycle hydraulic clutch actuator FIG. 1-4 saves the lives of the motorcycle operator and passenger. The linked dual action motorcycle hydraulic clutch actuator FIG. 1-4 prevents injury to pedestrians and bystanders. The linked dual action motorcycle hydraulic clutch actuator FIG. 1-4 saves the lives of pedestrians and bystanders. The linked dual action motorcycle hydraulic clutch actuator FIG. 1-4 prevents damage to the motorcycle that has been retrofitted with this invention. The linked dual action motorcycle hydraulic clutch actuator FIG. 1-4 prevents damage to other motorcycles, automobiles, and property. The linked dual action motorcycle hydraulic clutch actuator FIG. 1-4 prevents injury to passengers in other automobiles. The linked dual action motorcycle hydraulic clutch actuator FIG. 1-4 saves the lives of passengers in other automobiles. The linked dual action motorcycle hydraulic clutch actuator FIG. 1-4 reduces danger by preventing the motorcycle from stalling in the middle of traffic. The linked dual action motorcycle hydraulic clutch actuator FIG. 1-4 reduces danger by preventing uncontrolled surging of the motorcycle into to other motorcycles, automobiles, property, pedestrians and bystanders. The linked dual action motorcycle hydraulic clutch actuator FIG. 1-4 reduces danger to other motorcycles, automobiles, property pedestrians and bystanders by preventing the motorcycle from falling over during slow speed maneuvers. The linked dual action motorcycle hydraulic clutch actuator FIG. 1-4 reduces danger to other motorcycles, automobiles, property, pedestrians and bystanders by enabling sudden emergency stops from high speed while the motorcycle is in gear with the engine running. The linked dual action motorcycle hydraulic clutch actuator FIG. 1-4 allows less initiated motorcycle riders to engage in riding and enjoying modern motorcycles resembling vintage motorcycles. The linked dual action motorcycle hydraulic clutch actuator FIG. 1-4 allows disabled motorcycle riders on three wheeled motorcycles (trikes) and motorcycles equipped with a side car, to enjoy the sport of motorcycling. The linked dual action motorcycle hydraulic clutch actuator FIG. 1-4 provides the means to accomplish precise clutch control of the motorcycle equipped with a hand gear shift lever.

The linked dual action motorcycle hydraulic clutch actuator FIG. 1-4 will find wide spread use within the custom motorcycle parts industry, custom motorcycle manufacturing industry, among individual custom motorcycle builders/enthusiasts, and among disabled motorcycle riders. The linked dual action motorcycle hydraulic clutch actuator FIG. 1-4 will be capable of being installed by one individual with minimal mechanical skills. Much time, labor and expense will be saved by preventing frequent replacement of damaged and frayed clutch control cables. Much time, labor and expense will be saved by preventing accidents. The savings in collision and liability insurance claims and premiums would be considerable. Private industry would employ many workers to manufacture, distribute, sell and install many units.

What is claimed is:

1. A linked dual action motorcycle hydraulic clutch actuator on a motorcycle, having an engine and a clutch, comprising of two hydraulic actuators linked together by a bell crank and two hydraulic actuators which are actuated by a hand clutch lever and a foot clutch lever; wherein the first force transmitting structure is a hollow tube filled with hydraulic fluid that has the first end connected to a hydraulic actuator that is connected to a hand lever and the second end connected a hydraulic actuator that is connected to the first end of the bell crank; wherein the second force transmitting structure is a hollow tube filled with hydraulic fluid that has the first end connected to a hydraulic actuator that is connected to the second end of the bell crank and the second end connected to a hydraulic actuator that is connected to the clutch; and a foot lever that is connected to a center pivot of the bell crank whereby either the hand lever or the foot lever would pivot the bell crank to actuate the clutch.

2. A linked dual action motorcycle hydraulic clutch actuator according to claim 1 wherein the second force transmitting structure is a hollow tube filled with hydraulic fluid that has the first end connected to a hydraulic actuator that is connected to the second end of the bell crank and the second end connected to a hydraulic actuator that is connected to the clutch; wherein the hollow tube from the hydraulic actuator that is connected to the second end of the bell crank can be routed in front of, under, over, behind or through the engine or motorcycle frame to the hydraulic actuator that is connected to the clutch.

3. A linked dual action motorcycle hydraulic clutch actuator according to claim 1 comprising: a motorcycle clutch actuator for installation on a motorcycle; a clutch linkage that is foot actuated and hand actuated; a foot clutch actuator linked to a hand clutch actuator.

4. A linked dual action motorcycle hydraulic clutch actuator according to claim 1 comprising: hydraulic actuators of the invention to redirect the force originating from the foot clutch lever or the hand clutch lever to the final element in the clutch actuation system; hollow tubes filled with hydraulic fluid, said hollow tubes that will transfer the force originating from the foot clutch lever or hand clutch lever to hydraulic actuators and the final element in the clutch actuation system.

5. A linked dual action motorcycle hydraulic clutch actuator according to claim 1 comprising: a bell crank, attached to the center pivot of the bell crank which links the hand clutch lever to the foot clutch lever.

6. A linked dual action motorcycle hydraulic clutch actuator according to claim 1 comprising: a foot clutch lever attached to the center pivot of the bell crank to enable clutch actuation with the foot.

7. A linked dual action motorcycle hydraulic clutch actuator according to claim 1 comprising: a hand clutch lever to enable clutch actuation with the hand.

8. A linked dual action motorcycle hydraulic clutch actuator according to claim 1, which links the hand clutch lever to the foot clutch lever to enable the actuation of the clutch with either a hand clutch lever or a foot clutch lever.

9. A linked dual action motorcycle hydraulic clutch actuator according to claim 1, which provides a hand clutch lever, to hold the clutch in the disengaged position, with the motor running and the transmission in gear.

10. A linked dual action motorcycle hydraulic clutch actuator according to claim 1, which provides a foot clutch lever, to hold the clutch in the disengaged position, with the motor running and the transmission in gear.

11. A linked dual action motorcycle hydraulic clutch actuator according to claim 1, which provides a hand clutch lever, to engage the clutch through the release of positive pressure from a hand clutch lever.

12. A linked dual action motorcycle hydraulic clutch actuator according to claim 1, which provides a foot clutch lever, to engage the clutch through the release of positive pressure from a foot clutch lever.
